(19) United States
(12) Patent Application Publication
(10) Pub. No.: US 2012/0102702 A1
(43) Pub. Date: May 3, 2012

(54) TOOLS FOR ENGAGING CHECK VALVES OF BACKFLOW PREVENTION DEVICES

(76) Inventor: Jeff Mitchell, Jupiter, FL (US)

(21) Appl. No.: 13/287,989

(22) Filed: Nov. 2, 2011

Related U.S. Application Data
(60) Provisional application No. 61/409,157, filed on Nov. 2, 2010.

(51) Int. Cl. B23P 19/04

(52) U.S. Cl. 29/426.1; 29/221.6

(57) ABSTRACT

Tools are provided to facilitate the removal and installation of first and second check valves from backflow prevention devices. A tool for a first check valve includes a frame having a straight central portion with a plurality of leg portions extending from the central portion. The leg portions can be configured such that, when the tool is brought into engagement with a first check valve, each leg potion can be at least partially received in a respective recess on the base of a first check valve. A tool for a second check valve can include a plurality of arms. The arms can be configured so that, when the tool is brought into engagement with a second check valve, each arm can engage a respective pin provided on the base of a second check valve. The tools can be adapted to be engaged by another tool, such as a socket wrench.

### CROSS-REFERENCE TO RELATED APPLICATIONS

This application claims the benefit of U.S. Provisional Application No. 61/409,157, filed on Nov. 2, 2010, which is incorporated herein by reference in its entirety.

### FIELD

Embodiments relate in general to backflow prevention devices and, more particularly, to the removal and/or installation of components from backflow prevention devices.

### BACKGROUND

Federal and state laws require water suppliers to protect their potable water systems from contamination. One way in which contamination can occur is when water with non-potable substances flows back into the potable water system. Backflow can arise when backsiphonage and/or backpressure conditions are present in the water system. Either of these conditions can result in the direction of water flow in the system to reverse.

There are various types of devices that can be used to prevent the backflow of water. One type of backflow prevention device uses a double check valve system. An example of such a backflow prevention device is shown in U.S. Pa. No. 5,046,525. The check valves permit the flow of water in only one direction through each valve. Thus, in the event of backflow, water that has already passed through one of the check valves cannot flow back through the same check valve in the opposite direction. Two check valves are employed as a redundancy in case one of the valves fails.

The check valves must be tested periodically; the frequency of such testing may be governed by state or local laws and/or regulations. If a check valve fails testing, then the check valve must be removed from the backflow prevention device for repair or replacement. However, removal of the check valves by hand can be a difficult if not impossible task, as the check valves can become stuck in the device. In such cases, at least one manufacturer recommends removal of a first check valve by placing the blade end of a screwdriver against the body of the first check valve and tapping on the handle end of the screwdriver with a mallet or hammer. In this way, the screwdriver directly impacts the first check valve body in an effort to loosen it from engagement with the casing of backflow prevention device. However, if too much force is exerted, the first check valve can be damaged by the screwdriver, potentially ruining a valve that is in otherwise good working condition.

If the second check valve cannot be removed by hand, at least one manufacturer recommends its removal by pacing a screwdriver between posts provided on the body of the second check valve. A pressure is applied to the screwdriver to loosen the engagement between the second check valve and the casing of backflow prevention device. However, if the force applied by the screwdriver is unbalanced, then the screwdriver can slip, potentially damaging the second check valve and/or harming the user, such as if the user's hand impacts one of the posts.

Thus there is a need for systems and methods to minimize such concerns.

### SUMMARY

In one respect, embodiments are directed to a tool adapted for engaging a first check valve of a backflow prevention device. The tool includes a frame having a central portion and an end leg portion provided at each end of the central portion. The end leg portions can be angled at substantially 90 degrees relative to the central portion. The central portion of the frame can be substantially straight.

The tool can also include a first transverse leg portion that extends from the central portion of the frame. The first transverse leg portion includes a first portion that extends directly from the central portion at substantially 90 degrees relative to the central portion. The first transverse leg portion includes a second portion that extends at substantially 90 degrees relative to the first portion. The second portion can be substantially parallel to the end leg portions. The end leg portions and the first transverse leg portion are configured to be at least partially received in a respective recess provided in a first check valve of a backflow prevention device. The tool can further include a brace. The brace can be attached at one end to the first transverse leg portion; the brace can be attached at another end to one of the end leg portions.

The tool can include a second transverse leg portion that extends from the central portion of the frame on an opposite side thereof from the first transverse leg portion. The second transverse leg portion can include a first portion that extends directly from the central portion at substantially 90 degrees relative to the central portion. The second transverse leg portion can include a second portion that extends at substantially 90 degrees relative to the first portion. The second portion can be substantially parallel to the end leg portions. The second transverse leg portion can be configured to be at least partially received in a respective recess provided in the first check valve of the backflow prevention device. The second transverse arm can be offset from the first transverse arm. The tool can further include a brace. The brace can be attached at one end to the second transverse leg portion; the brace can be attached at another end to one of the end leg portions.

The tool can be adapted for engagement by another tool. The tool can include a structure having an opening sized to receive and engage at least a portion of a male fitting of a socket wrench. In one embodiment, the structure can be a socket.

In another respect, embodiments are directed to a tool adapted for engaging a second check valve of a backflow prevention device. The tool can have a body that has an associated axis of rotation. The body includes a plurality of arms extending radially outward from the axis of rotation. The arms are configured to engage a respective pin provided on a second check valve of a backflow prevention device. The arms can be substantially straight. The arms can be substantially coplanar. At least one of the arms can be angled at substantially 90 degrees relative to a neighboring arm. At least one of the arms can be angled at about 60 degrees or less relative to a neighboring arm. The tool can be adapted for engagement by a socket wrench.

In one embodiment, the tool can have four arms. In such case, a first pair of arms can be substantially aligned with each other, and a second pair of arms can be substantially aligned with each other. Alternatively, a first pair of arms can be substantially aligned with each other so as to define a longitudinal axis. The four arms can be arranged on substantially only one side of the longitudinal axis.

In another respect, embodiments are directed to a method of removing check valves from a backflow prevention device. The backflow prevention device includes a housing and a first check valve threadably engaging the housing. The first check valve includes a plurality of recesses formed therein. The first check valve can include a base. The recesses can be formed in the base.

According to the method a tool for engaging the first check valve is provided. The tool includes a frame with a central portion and an end leg portion provided at each end of the central portion. Each end leg portion is angled at substantially 90 degrees relative to the central portion. The tool further includes a first transverse leg portion that extends from the central portion of the frame. The first transverse leg portion includes a first portion that extends directly from the central portion at substantially 90 degrees relative thereto and a second portion that extends at substantially 90 degrees relative to the first portion. The second portion is substantially parallel to the end leg portions. The end leg portions and the first transverse leg portion are configured to be at least partially received in a respective recess provided in a first check valve of the backflow prevention device.

The tool is brought into engagement with the first check valve such that each of the end leg portions and the first transverse leg portion is at least partially received in a respective one of the recesses in the first check valve. A force can be applied to the tool, such as by hand and/or by another tool, so as to rotate the tool about an axis of rotation. The rotation of the tool can be transmitted to the first check valve due to the engagement between the recesses and the end leg portions as well as the first transverse leg portion of the tool. As a result, the first check valve can turn.

The backflow prevention device can further include a second check valve that threadably engages the housing. A plurality of pins can be provided on the second check valve. According to the method, a tool for engaging the second check valve can be provided. The tool can have a body and an axis of rotation. The body can include a plurality of arms extending radially outward from the axis of rotation.

### BRIEF DESCRIPTION OF THE DRAWINGS

FIG. 1 is a side elevation cross-sectional view of a backflow prevention device having a double check valve system.

FIG. 2 is a view of a first check valve of a backflow prevention device.

FIG. 3 is a view of a second check valve a backflow prevention device.

FIG. 4 is a view of an example of a removal tool for a first check valve.

FIG. 5 is a top plan view of the removal tool for a first check valve shown in FIG. 4.

FIG. 6 is a view of another example of a removal tool for a first check valve.

FIG. 7 is a top plan view of the removal tool for a first check valve shown in FIG. 6.

FIG. 8 is a view of an example of a removal tool for a second check valve.

FIG. 9 is a view of another example of a removal tool for a second check valve.

FIG. 10 shows an example of the removal tool engaging a first check valve.

FIG. 11 shows an example of the removal tool engaging a second check valve.

FIG. 12 shows an example of a method for removing and installing check valves in a backflow prevention device.

### DETAILED DESCRIPTION

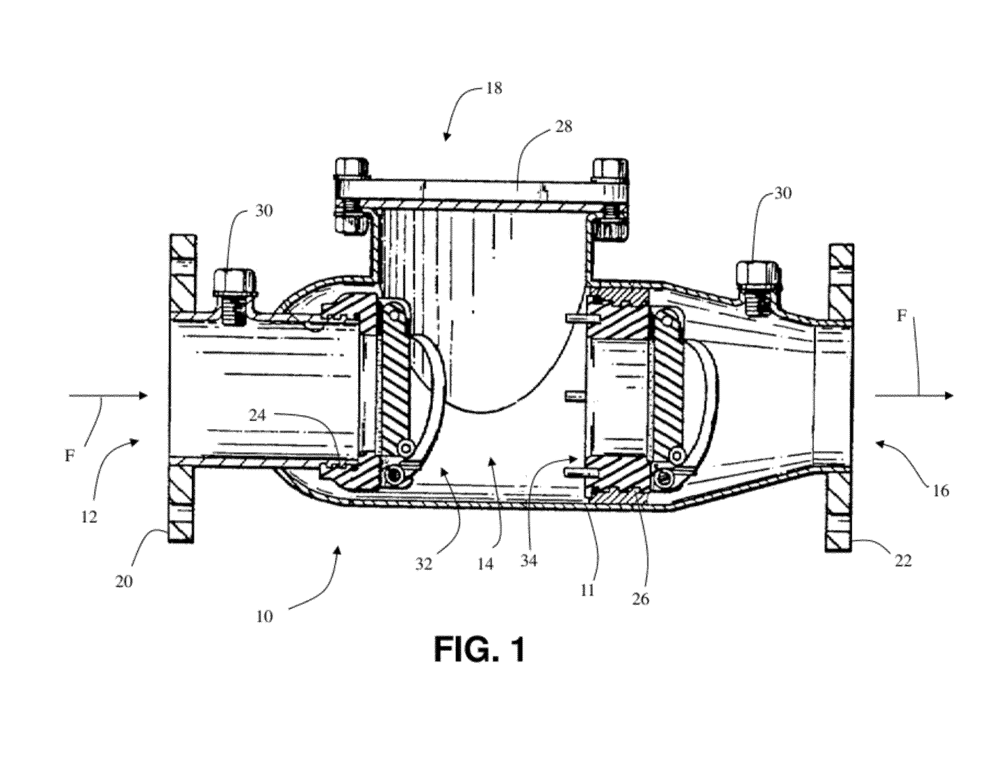

Arrangements described herein relate to tools for removing check valves from backflow prevention devices and associated methods. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 1-12, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Before describing the tools for removing check valves from backflow prevention devices, a backflow prevention device and some of its components will be generally described. FIG. 1 shows a portion of a known backflow prevention device 10 having a double check valve system. The backflow prevention device 10 can be operatively connected along a water supply conduit that allows fluid communication between a water source and an end user. The backflow prevention device 10 can range in sizes. Examples of backflow prevention devices that are currently available include the 2000SS and 4000SS available from Ames Fire & Waterworks, Sacramento, Calif. as well as the 774 and 994 available from Watts Water Technologies, Inc., North Andover, Mass.

The backflow prevention device 10 has a housing 11. The housing 11 can include an inlet port 12, a central chamber 14, an outlet port 16, and a service port 18. The inlet port 12 can include a flange 20 for attachment to an upstream isolation valve or section of a supply conduit or pipe. The outlet port 16 can include a flange for attachment to a downstream isolation valve or section of a supply conduit or pipe. A portion of the inlet port 12 can be configured with threads 24 thereon. Similarly, the outlet port 16 can be configured with threads 26 thereon. The backflow prevention device 10 can include a cap or cover 28 engaging the service port 18. The service port 18 can allow a user to access the central chamber 14. The backflow prevention device 10 can include test cock fittings 30.

Within the housing 11, there can be two check valves—a first check valve 32 (also referred to as a number one check valve) and a second check valve 34 (also referred to as a number two check valve). The terms “first” and “second” are used relative to the direction of normal fluid flow F through the back flow prevention device. The first and second check valves 32, 34 are typically spaced apart in the fluid flow direction F and can be separated by the central chamber 14. The first and second check valves 32, 34 can engage the housing 11 of the backflow prevention device 10 in any suitable manner, such as by engagement with the threads 24, 26, respectively. An example of the structure and operation of the first and second check valves as well as a backflow prevention device is described in U.S. Pat. No. 5,046,525, which is incorporated herein by reference in its entirety.

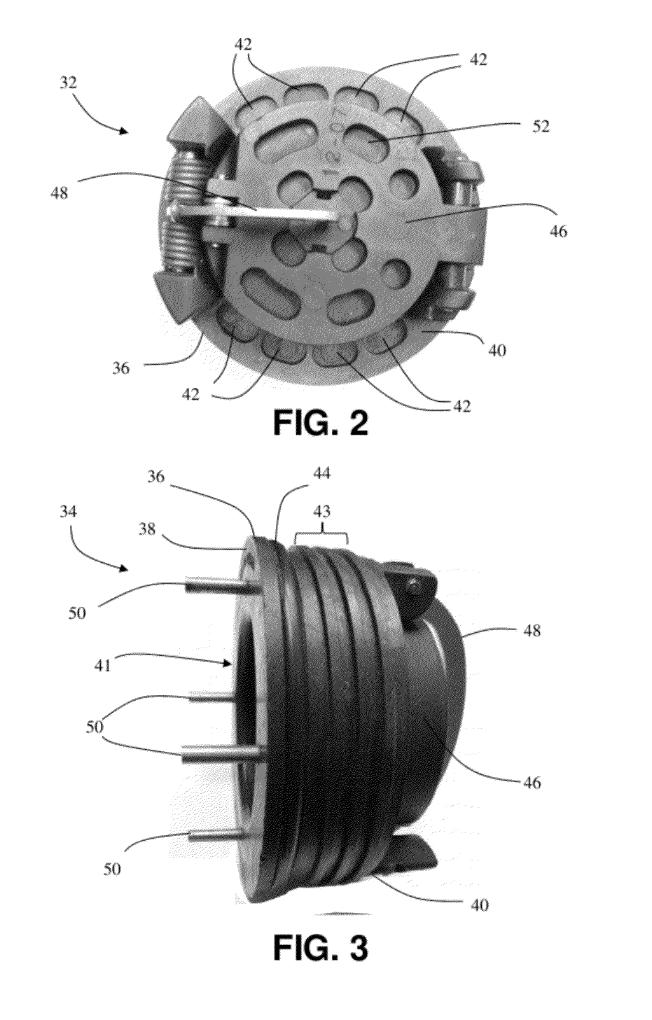

FIG. 2 shows an example of a first check valve 32. The first check valve 32 includes a base 36 having an inlet side 38 and an outlet side 40. An aperture (see FIG. 3 for a similar aperture in the second check valve 34) to allow the flow of fluid therethrough. The outlet side of the base 36 can have a plurality of recesses 42 provided therein. Any number of recesses 42 can be provided. In the embodiment shown in FIG. 2, there can be eight recesses provided in the outlet side 40 of the base 36. The recesses 42 can be distributed in any suitable manner. The recesses 42 can be substantially identical to each other, or at least one of the recesses 42 can be different from the other recesses in one or more respects.

In one embodiment, the base 36 can also include external threads 43 (see FIG. 3 for a similar aperture in the second check valve 34) for attachment within the housing 11; however, other forms of attachment (and associated features) to the housing 11 are possible. The first check valve 32 can engage a portion of the housing 11 of the backflow prevention device 10 such that the outlet side 40 faces toward the central chamber 14. An O-ring 44 (see FIG. 3 for a similar aperture in the second check valve 34) can be provided around the base proximate to the inlet side 38 for sealing engagement with the housing 11.

The first check valve 32 can include a clapper 46 pivotally mounted to a portion of the base 36, such as the outlet side 40 thereof. A resilient sealing disc (not shown) can be attached to the underside of the clapper 46 to provide a fluid tight seal over the aperture in the base 36 when the clapper 46 is in a closed or engaged position. The first check valve 32 can also include a cam arm 48 pivotally attached to the base 36.

FIG. 3 shows an example of a second check valve 34. The above discussion of the first check valve 32 can apply equally to the second check valve 34. In addition, a plurality of pins 50 can protrude from the inlet side 38 of the base 36. There can be any number of pins 50. In some instances, there can be four pins 50, as may be found on relatively small second check valves. A “relatively small second check valve” is one that is sized less than 6 inches and, more particularly, one that is 4 inches or less and, still more particularly, one that ranges from 2½ inches to 4 inches. It should be noted that these sizes indicate the size of the service pipe. In other instances, there can be fewer or even more pins 50. For example, there can be five pins 50, as may be found on relatively large second check valves. A “relatively large second check valve” is one that is sized 6 inches or more and, more particularly, one that ranges from 6 inches to 8 inches. Again, these sizes indicate the size of the service pipe. The pins 50 can have any suitable size or shape. The pins 50 can be substantially identical to each other or at least one of the pins 50 can be different from the other pins 50 in one or more respects.

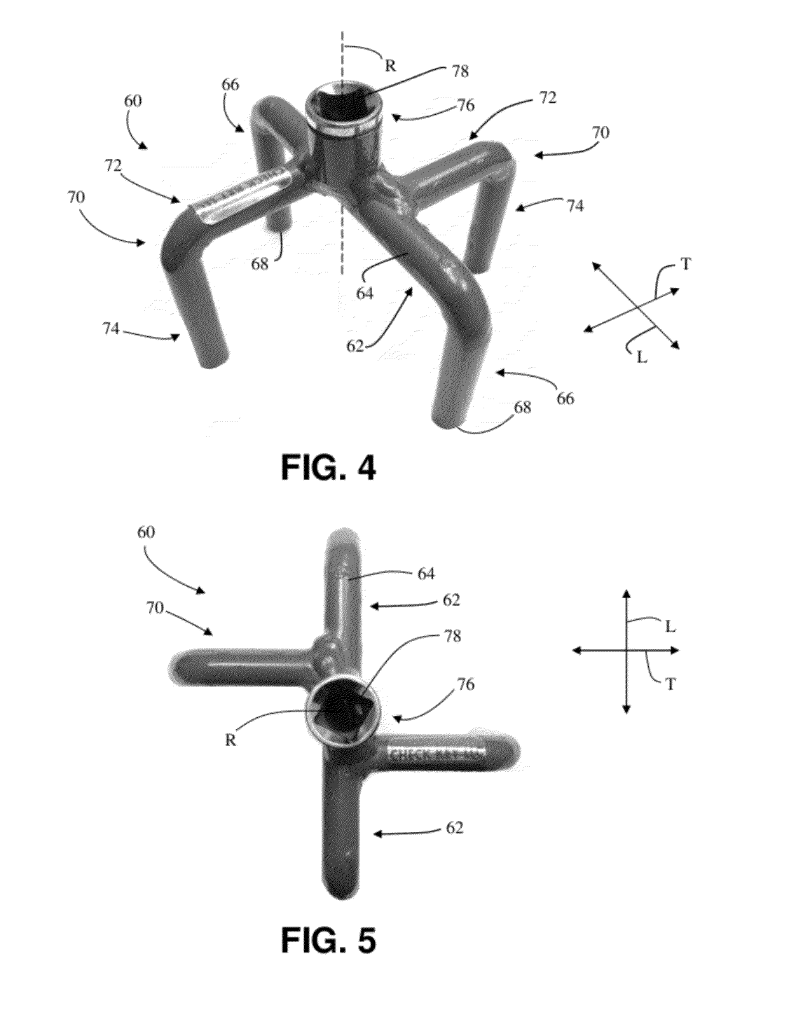

Embodiments herein are directed to tools to facilitate the removal of the check valves 32, 34 from a backflow prevention device 10. FIGS. 4-5 show an example of a removal tool 60 for the first check valve 32. The tool 60 shown can be sized based on the size of the first check valve 32. With respect to the embodiment shown in FIGS. 4-5, the tool 60 is sized for removing relatively small first check valves. A “relatively small first check valve” is one that is sized less than 6 inches and, more particularly, one that is 4 inches or less and, still more particularly, one that ranges from 2½ inches to 4 inches. It should be noted that these sizes indicate the size of the service pipe. However, embodiments are not limited to this size range, as the tool 60 can be sized as appropriate to fit the size of the first check valve. The first check valve removal tool 60 can have an associated axis of rotation R, longitudinal direction L and transverse direction T, which can all be substantially orthogonal to each other.

The first check valve removal tool 60 can include a frame 62 having an elongated central portion 64 with an end leg portion 66 at each end of the central portion 64. The central portion 64 can be substantially straight. However, in some instances, the central portion 64 can include one or more bends, curves, jogs or other non-straight feature. The central portion 64 can define the longitudinal direction L of the tool 60.

The end leg portions 66 can be angled relative to the central portion 64 at any suitable angle. In one embodiment, the end leg portions 66 can be angled at substantially 90 degrees to the central portion 64. “Substantially 90 degrees” means 90 degrees and slight variations therefrom. Each of the end leg portions 66 can include an end 68. The end legs portions 66 can be substantially straight. The end leg portions 66 can extend substantially parallel to each other and/or to the axis of rotation R of the first check valve removal tool 60.

The frame 62 can be a unitary construction. In such case, an elongated bar or piece of material can be bent or formed into the desired shape. In some instances, the frame 62 may be formed by a plurality of pieces. For instance, the central portion 64 and the end leg portions 66 can be formed as separate pieces that are joined together in any suitable manner, such as by welding, brazing, adhesives, fasteners and/or mechanical engagement.

In some embodiments, the first check valve removal tool 60 can include at least two end leg portions 66. However, in other embodiments, additional end leg portions can be provided. Indeed, there can be an end leg portion for each recess 42 provided in the first check valve 32. In one embodiment, as is shown in FIGS. 4-5, the first check valve removal tool 60 can include four end legs. In such case, transverse leg portions 70 can be provided in addition to the end leg portions.

The transverse leg portions 70 can extend from the frame 62. In one embodiment, the transverse leg portions 70 can extend generally in the transverse direction T from the central portion 64 of the frame 62. The transverse leg portions 70 can extend from the frame 64 at any suitable angle. In one embodiment, the transverse leg portions 70 can extend at substantially 90 degrees relative to the central portion 64 of the frame 62. A first portion 72 of one or more of the transverse leg portions 70 can extend substantially straight from the frame 62. The first portion 72 can transition to a second portion 74 that is angled relative to the first portion 72. In one embodiment, the first and second portions 72, 74 can be angled at substantially 90 degrees relative to each other. The first portion 72 of the transverse leg portions 70 can be substantially coplanar with the central portion 64 of the frame 62; that is, a longitudinal axis (not shown) associated with each of the first portions 72 can lie in substantially the same plane as a longitudinal axis (not shown) associated with the central portion 64.

The transverse leg portions 70 can be provided on opposite sides of the frame 62, as is shown in FIG. 4. The transverse leg portions 70 can be substantially aligned with each other. Alternatively, as shown in FIG. 5, the transverse leg portions 70 can be offset from each other. The first portions 72 of the transverse leg portions 70 can be substantially parallel to each other. The second portions 74 of the transverse leg portions 70 can be substantially parallel to each other and/or substantially parallel to the end leg portions 66 of the frame 62. The transverse leg portions 70 can be substantially identical to each other or they can be different from each other in one or more respects. The transverse leg portions 70 can be formed as a unitary construction with the frame 62. Alternatively, the transverse leg portions 70 can be formed separately from the frame 62 and subsequently attached thereto, such as by welding, brazing, adhesives, fasteners and/or mechanical engagement.

While the first check valve removal tool 60 in FIGS. 4-5 is shown as having four leg portions 66, 70, it will be understood that embodiments are not limited to such a configuration. Indeed, the first check valve removal tool 60 can have fewer leg portions, such as two or three leg portions. Or, the first check valve removal tool 60 can have more leg portions, such as five, six, seven or eight leg portions.

The first check valve removal tool 60 can be sized such that, when brought into engagement with the first check valve 32, at least a portion of the end leg portions 66 and the transverse leg portions 70 are received in a respective one of the recesses 42 and/or recesses 52 in the first check valve 32. The leg portions 66, 70 can be any suitable size or shape. In one embodiment, the leg portions 66, 70 can have a circular cross-sectional shape. In such case, the diameter of the leg portions 66, 70 can be about ½ inch or other size so as to fit within the recesses 42 and/or recesses 52. However, in other embodiments, the cross-sectional shape of the leg portions 66, 70 can be oval, rectangular, trapezoidal, triangular, just to name a few possibilities. The length of the second portion 74 of the leg portions 66, 70 can be determined by the geometry of the first check valve 32 to avoid interferences therewith. The size and/or shape of the leg portions 66, 70 can be substantially constant, or the size and/or shape of one or more of the leg portions 66, 70 can vary along at least a portion of its length.

The first check valve removal tool 60 can be made of any suitable material. For instance, the first check valve removal tool 60 can be made of steel. More particularly, the first check valve removal tool 60 can be made of a round mild steel bar. In one embodiment, the steel bar can be about ½ inch in diameter.

The first check valve removal tool 60 can be configured to facilitate engagement with another tool. As an example, the first check valve removal tool 60 can be configured for engagement by a socket wrench. To that end, a socket 76 can be attached to the main frame element of the first check valve removal tool 60, such as by welding, brazing, adhesives, fasteners and/or mechanical engagement. As an alternative, any structure with an opening 78 sized to receive and engage a portion of a male fitting of a socket wrench can be attached to the frame 62 of the first check valve removal tool 60. Still alternatively, a structure including any type of screw drive for engagement by any type of tool can be attached to the frame 62 of the first check valve removal tool 60. For example, the first check valve removal tool 60 can include a hex head (not shown) for engagement by a crescent-type wrench, an open-end wrench, or a socket.

The first check valve removal tool 60 can be coated with any material to provide protection and/or for aesthetic reasons. In one embodiment, at least a portion of the first check valve removal tool 60 can be painted. Portions of the check valve removal tool 60 can be coated with a lubricant or a rust inhibiting substance.

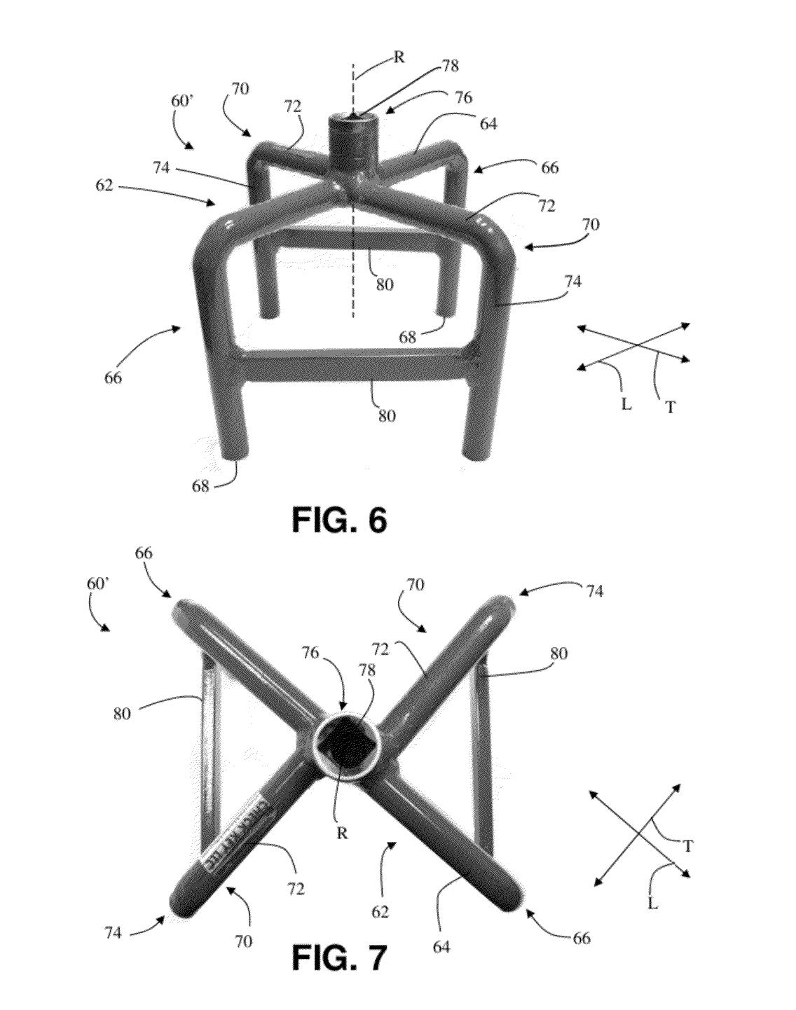

FIGS. 6-7 show another embodiment for a removal tool 60′ for a first check valve. The above discussion of the removal tool 60 shown in FIGS. 4-5 applies equally to the removal tool 60′. The removal tool 60′ may be beneficial for relatively large first check valves 32. A “relatively large first check valve” is one that is sized 6 inches or more and, more particularly, one that ranges from 6 inches to 8 inches. The removal tool 60′ is different from the removal tool 60 shown in FIGS. 4-5 in that it is larger and the end portions 66, 70 are longer to avoid interferences with the cam arm 48 on the larger first check valves 32. Further, the first check valve removal tool 60′ can include additional features that can provide structural strength to the tool 60′. For instance, the removal tool 60′ can include one or more braces 80. The braces 80 can be made of any suitable material, including the same material as the leg portions 66, 70. For instance, the braces 80 can be made of steel. The braces 80 can be attached to portions of the removal tool 60′ in any suitable manner, including, for example, by welding, brazing, adhesives, fasteners and/or threaded engagement.

In one embodiment, two braces 80 can be provided. Each brace 80 can be joined at one end to a leg potion 66, 70. For instance, one end of the brace 80 can be attached to an end leg potion 66, and the other end of the brace 80 can be attached to a transverse leg portion 70. As is shown in FIG. 7, the braces 80 can extend substantially parallel to each other. While two braces 80 are shown in FIGS. 6-7, it will be understood that embodiments are not limited to two braces 80. Indeed, there can be fewer braces 80. In some instances, there can be more than two braces 80. Such a brace 80 could be angled at about 90 degrees relative to the braces 80 shown in FIGS. 6-7.

When there is a plurality of braces 80, the braces 80 can be substantially identical to each other, or at least one of the braces 80 can be different in one or more respects. The braces 80 can have any suitable size or cross-sectional shape. As an example, the braces 80 can be substantially rectangular in cross-sectional shape; however, it will be understood that other cross-sectional shapes are possible. The braces 80 can be substantially straight, or they can include one or more non-straight features.

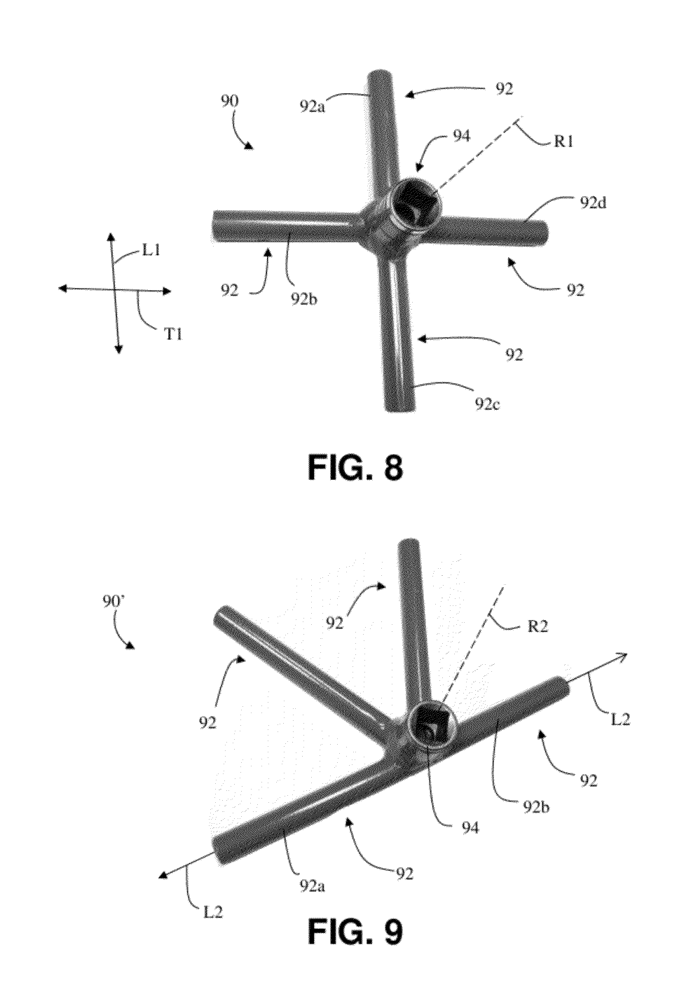

Similar to the first check valve 32, tools can be provided to facilitate the removal of the second check valve 34. FIG. 8 show an example of a removal tool 90 for the second check valve 34. The tool 90 can be sized as appropriate to fit the size of the second check valve 90. The second check valve removal tool 90 can have an associated axis of rotation R1, longitudinal direction L1 and transverse direction T1, which can all be substantially orthogonal to each other. The removal tool 90 can be adapted to engage the pins 50 of a second check valve 34.

In one embodiment, the second check valve removal tool 90 can include a plurality of arms 92 extending radially outward from the axis of rotation R1. The arms 92 can extend from the axis R1 in any suitable manner. The arms 92 can be arranged in any suitable manner. The arrangement of the arms 92 can be based on at least in part on the arrangement of the pins 50 on the second check valve 34. The arms 92 can be substantially coplanar; that is, a longitudinal axis (not shown) associated with each arm 92 can be substantially in the same plane as the longitudinal axis (not shown) associated with each of the other arms 92.

One example of a second check valve removal tool 90 is shown in FIG. 8. This embodiment can be suitable for engaging the pins 50 of relatively small second check valves 34, such as those sized from 2½ inches to 4 inches. These second check valves 34 typically have four pins 50, which can be substantially equally spaced thereon.

The arms 92 can be substantially straight. However, in some instances, one or more of the arms 92 can include one or more bends, curves, jogs or other non-straight feature. Each arm 92 can be angled relative to a neighboring arm 92. As shown in FIG. 8, each arm can extend at substantially 90 degrees relative to a neighboring arm 92. Two of the arms 92—a first arm 92a and a third arm 92c—can be substantially aligned with each other. Another pair of the arms 9—a second arm 92b and a fourth arm 92d—can be substantially aligned with each other. While FIG. 8 shows the removal tool 90 as having 4 arms, it will be understood that embodiments can include removal tools 90 with fewer arms 92 or even a greater numbers of arms 92. The number of arms 92 can be equal to the number of pins 50 on the second check valve 34. However, in some instances, the number of arms 92 can be different from the number of pins 50 on the second check valve 34.

The arms 92 can be any suitable size or shape. In one embodiment, the arms 92 can have a circular cross-sectional shape. In such case, the diameter of the arms 92 can be about ½ inch. However, in other embodiments, the cross-sectional shape of the arms 92 can be oval, rectangular, trapezoidal, polygonal, triangular, just to name a few possibilities. The length and distribution of the arms 92 can be determined by the geometry of the second check valve 34. The size and/or shape of the arms 92 can be substantially constant, or the size and/or shape of one or more of the arms 92 can vary along at least a portion of its length.

The second check valve removal tool 90 can be made of any suitable material. For instance, the second check valve removal tool 90 can be made of steel. More particularly, the second check valve removal tool 90 can be made of a round mild steel bar.

In the embodiment shown, the tool 90 can be made of three separate pieces - one long piece and two smaller pieces. For instance, the first and third arms 92a, 92c can be made of a single piece of material, and the second and fourth arms 92b, 92d can be separate pieces which can be subsequently joined to the single piece forming the first and third arms 92a, 92c. Such joining can be achieved in any suitable manner, including, for example, by welding, brazing, adhesives, fasteners and/or mechanical engagement.

The second check valve removal tool 90 can be configured to facilitate engagement with another tool. As an example, the second check valve removal tool 90 can be configured for engagement by a socket wrench. To that end, a socket 94 can be attached to the second check valve removal tool 90, such as by welding, brazing, adhesives, fasteners and/or mechanical engagement. The socket 94 can be positioned in any suitable location of the second check valve removal tool 90. For instance, the socket 94 can be centrally located on the second check valve removal tool 90 such that the axis of rotation R1 passes through at least a portion of the socket 93.

As an alternative, any structure with an opening sized to receive and engage a portion of a male fitting of a socket wrench can be attached to the second check valve removal tool 90. Still alternatively, a structure including any type of screw drive for engagement by any type of tool can be attached to the second check valve removal tool 90. For example, the second check valve removal tool 90 can include a hex head (not shown) for engagement by a crescent-type wrench, an open-end wrench, or a socket.

The second check valve removal tool 90 can be coated with any material to provide protection and/or for aesthetic reasons. In one embodiment, the second check valve removal tool 90 can be painted. Portions of the second check valve removal tool 90 can be coated with a lubricant or a rust inhibiting substance.

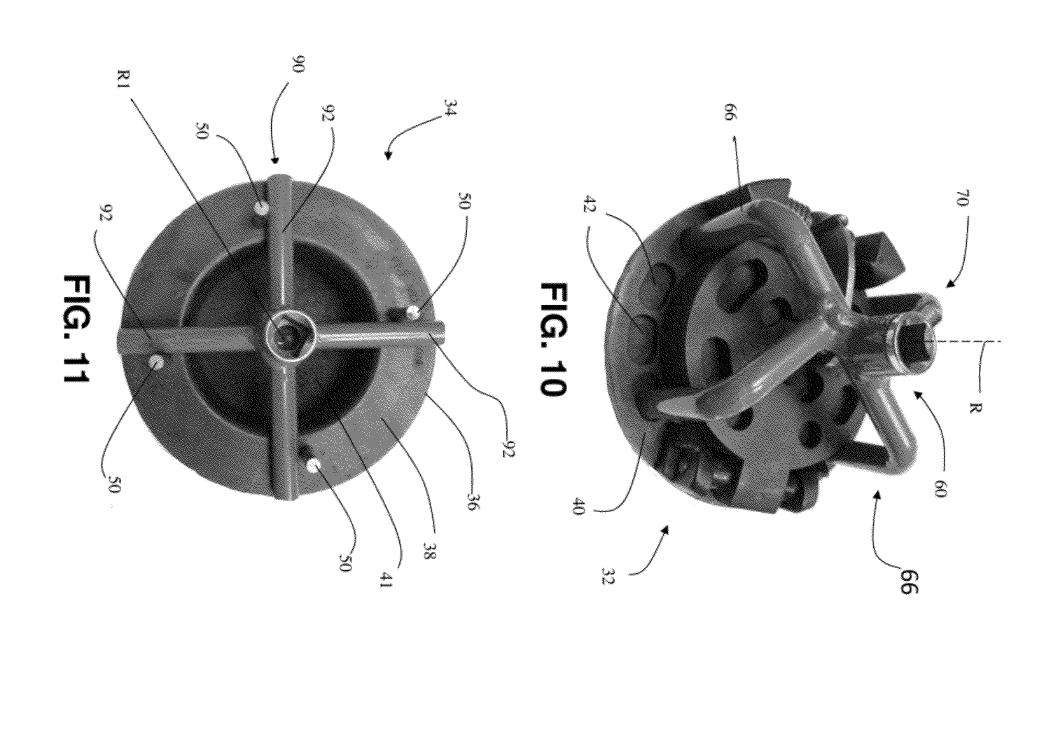

FIG. 9 shows another embodiment of a removal tool for a second check valve 90′. In one embodiment, the tool shown can be sized for removing the second check valve, ranging from 6 inches or greater. The second check valve removal tool 90′ can have an associated axis of rotation R2 and longitudinal direction L2, which can be substantially orthogonal to each other. The removal tool 90′ can be adapted to engage the pins 50 of a second check valve 34. The above discussion of the removal tool 90 shown in FIG. 8 applies equally to the removal tool 90′.

In the embodiment shown in FIG. 9, the check valve removal tool can have four arms 92, but the arms 92 can be arranged so that they are at or on one side of the longitudinal axis L2 of the tool 90′. Two of the arms 92a, 92b can be substantially aligned with each other. Each arm 92 can be angled relative to an adjacent arm 92. As shown in FIG. 9, each arm 92 can extend at about 60 degrees or less relative to an adjacent arm 92. The relative position between neighboring arms 92 can be substantially the same, or at least one pair of neighboring arms 92 can have a different relative positioning. The arms 92 can be substantially coplanar; that is, a longitudinal axis (not shown) associated with each arm 92 can be substantially in the same plane as the longitudinal axis (not shown) associated with each of the other arms 92.

While the second check valve removal tools 90, 90′ are shown in FIGS. 8-9 as having four arms 92, it will be understood that embodiments are not limited to such a configuration. Indeed, the second check valve removal tools 90 and/or 90′ can have fewer arms 92, such as two or three arms. Or, the second check valve removal tools 90 and/or 90′ can have more arms, such as five, six, seven or eight arms. In some instances, the number of arms 92 can equal the number of pins 50 on the second check valve 34, but, in other embodiments, they can be different. For instance, the check valve removal tool 90′ shown in FIG. 9 could be used to engage four of the pins 50 on a second check valve 34 that has five or more pins 50, as sometimes provided on second check valves that are sized 6 inches or greater.

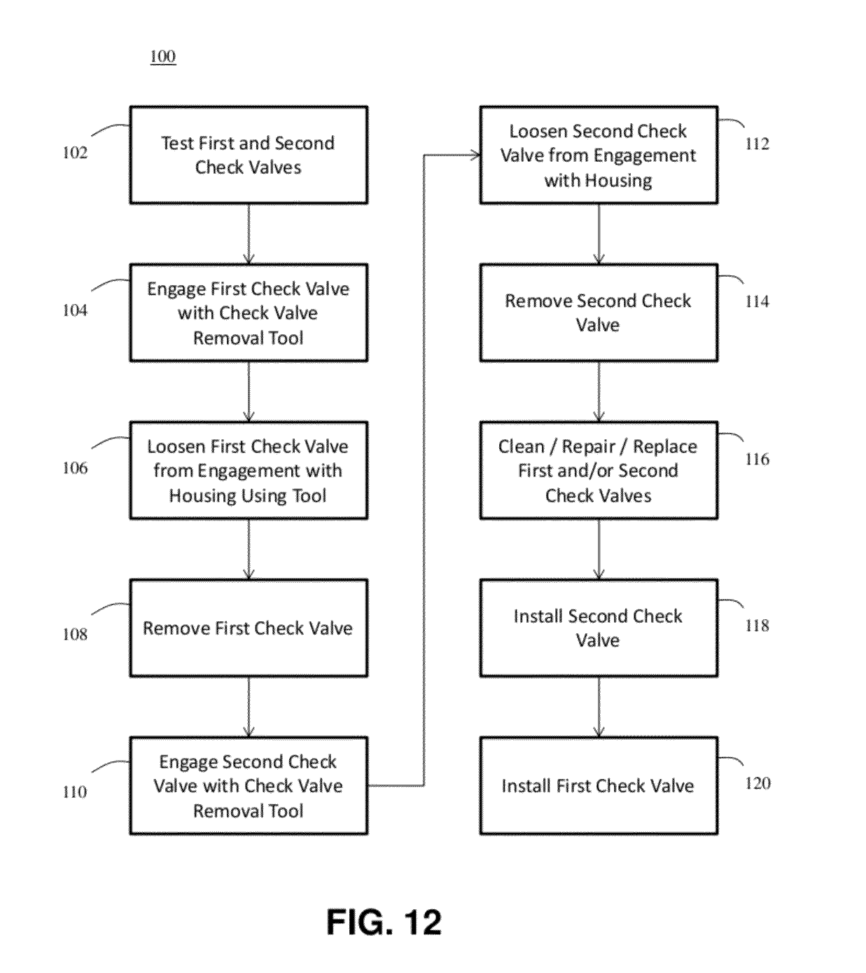

Now that the various configurations of the check valve removal tools have been described, one manner of using the tools will now be described. It will be understood that the following description is merely exemplary. Referring to FIG. 12, a method 100 for removing and replacing check valves in a backflow prevention device is shown. Various possible steps of method 100 will now be described. The method 100 illustrated in FIG. 12 may be applicable to the embodiments described above in relation to FIGS. 1-9, but it is understood that the method 100 can be carried out with other suitable systems and arrangements. Moreover, the method 100 may include other steps that are not shown here, and in fact, the method 100 is not limited to including every step shown in FIG. 12. The steps that are illustrated here as part of the method 100 are not limited to this particular chronological order, either. Indeed, some of the steps may be performed in a different order than what is shown and/or at least some of the steps shown can occur simultaneously.

To test the first and second check valves 32, 34, the cover 28 on the backflow prevention device 10 can be removed to open the service port 18. At step 102, the first and second check valves 32, 34 can be tested in any suitable manner. If the first and/or second check valve 32, 34 fail testing, then the check valves can be removed from the backflow prevention device 10 for further inspection. To that end, a first check valve removal tool 60, 60′ can be inserted into the central chamber 14 of the backflow prevention device 10 through the service port 18. At step 104, the tool 60, 60′ can be brought into engagement with the first check valve 32 such that at least a portion of each end leg portion 66 and, if provided, transverse end leg 70 is received in a respective one of the recesses 42 in the base 36 and/or recesses 52 on the clapper 46. An example of such a condition is shown in FIG. 10. Naturally, an appropriately sized tool can be selected. For instance, for relatively small first check valves 32, such as those sized from less than 6 inches or, more particularly, from 2.5 inches to 4 inches, a check valve removal tool 60 configured such as the one shown in FIGS. 4-5 can be used. For relatively large first check valves 32, such as those sized from 6 inches or more, a check removal tool 60′ configured like the one shown in FIGS. 6-7 can be used. However, embodiments are not limited to these selections.

At step 106, the first check valve can be loosened from its engagement with the housing 11 of the backflow prevention device 10. Such loosening can include turning the removal tool 60, 60′, which, in turn, can turn the first check valve 32. To facilitate such turning, the first check valve removal tool 60, 60′ can be engaged by another tool. For instance, the socket 76 of the tool 60, 60′ can be engaged by a socket wrench. A force can be applied to the socket wrench such that the removal tool transfers the force to the first check valve 32. The first check valve 32 can turn and disengage from the backflow prevention device 10. Once sufficiently loosened, the first check valve 32 can be disengaged from the housing 11 by hand or the removal tool 60, 60′ can continue to be used. Once the first check valve 32 is disengaged, it can be removed from the backflow prevention device 10 through the service port 18, at step 108.

A second check valve removal tool 90, 90′ can be inserted into the central chamber 14 of the backflow prevention device 10. At step 110, the tool 90, 90′ can be brought into engagement with the second check valve 34. Such engagement can include at least a portion of each arm 92 of the tool 90, 90′ engaging a respective one of the pins 50 on the second check valve 34. An example of such a condition is shown in FIG. 11. It should be noted, however, that, depending on the configuration of the tool 90, 90′, there may be some posts of the second check valve 34 that are not engaged by an arm 92 of the tool 90, 90′. Again, an appropriately sized removal tool 90, 90′can be selected. For instance, for relatively small first check valves, such as those sized from 2.5 inches to 4 inches, a check valve removal tool 90 configured such as the one shown in FIG. 8 can be used. For relatively large check valves, such as those sized from 6 inches or more, a check removal tool 90′ configured like the one shown in FIG. 9 can be used. However, it will be understood that embodiments are not limited to these selections.

At step 112, the second check valve 34 can be loosened from its engagement with the housing 11 of the backflow prevention device 10. Such loosening can comprise turning the removal tool 90, 90′, which, in turn, can turn the second check valve 34. The second check valve removal tool 90, 90′ can be engaged by another tool. For instance, the socket 94 of the tool 90, 90′ can be engaged by a socket wrench. A force can be applied to the socket wrench such that the removal tool 90, 90′ transfers the force to the second check valve 34. The second check valve 34 can turn and become loosened from the backflow prevention device 10. Once sufficiently loosened, it may be possible to disengage the second check valve 34 from the housing 11 by turning the second check valve 34 by hand. Alternatively, the removal tool 90, 90′ can continue to be used to disengage the second check valve 34. At step 114, the second check valve 34 can be removed from the backflow prevention device 10, such as through the service port 18. It should be noted that, in at least some configurations of a backflow prevention device 10, the first check valve 32 may have to be removed before the second check valve 34 is removed due to, at least in part, space considerations.

The first and/or second check valves can be inspected to determine if the check valve can be repaired or if replacement is warranted. Such inspection can be performed visually or in any other suitable manner. At step 116, the first and/or second check valves 32, 34 can be cleaned, repaired, or discarded and replaced, as needed. At step 118, the second check valve 34 can be installed in the backflow prevention device 10. Such installation can include inserting the second check valve 34 into the central chamber 14 through the service port 18. The second check valve 34 can be brought into engagement with the housing 11 of the backflow prevention device 10. For instance, the second check valve 34 can be screwed into engagement with the threads. Such engagement may be performed at least partially by hand. In other embodiments, such engagement can be performed at least partially using a second check valve removal tool 90, 90′. In some instances, such engagement may be initially performed by hand and subsequently by use of the tool 90, 90′.

It should be noted that the various check valve removal tools 60, 60′, 90, 90′ described herein can be presented (e.g. assembled, packaged, sold, etc.) to a user in various ways. For instance, the check valve removal tools 60, 60′, 90, 90′ can be presented individually as separate pieces. Alternatively or in addition, the check valve removal tools 60, 60′, 90, 90′ can be presented in a preassembled kit for use and/or purchase by a user.

As an example, the kit can include at least one removal tool for first check valves that are relatively small in size (such as those sized less than 6 inches or, more particularly, from 2.5 inches to 4 inches), at least one removal tool for first check valves that are relatively large in size (such as those sized from about 6 inches or greater), at least one removal tool for second check valves that are relatively small in size (such as those sized less than 6 inches or, more particularly, from 2.5 inches to 4 inches), and at least one removal tool for second check valves that are relatively large in size (such as those sized from about 6 inches or greater). With such a kit, a user will be equipped to engage check valves of most common sizes.

As another example, a kit may be configured specifically for first check valves. The kit can include at least one removal tool for first check valves that are relatively small in size (such as those sized from 2.5 inches to 4 inches) and at least one removal tool for first check valves that are relatively large in size (such as those sized from about 6 inches or greater). With such a kit, a user will have the removal tools needed to engage first check valves of most common sizes.

As still another example, a kit may be configured specifically for second check valves. The kit can include at least one removal tool for second check valves that are relatively small in size (such as those sized from 2.5 inches to 4 inches) and at least one removal tool for second check valves that are relatively large in size (such as those sized from about 6 inches or greater). With such a kit, a user will have the removal tools needed to engage second check valves of most common sizes.

In yet a further example, a kit may be configured specifically for first and second check valves that are relatively small in size, such as those sized from 2.5 inches to 4 inches. The kit can include at least one removal tool for first check valves that are relatively small in size and at least one removal tool for second check valves that are relatively small in size. With such a kit, a user will be equipped to engage relatively small first and check valves that are most likely to be encountered.

In still a further example, a kit may be configured specifically for first and second check valves that are relatively large in size, such as those sized from about 6 inches or greater. The kit can include at least one removal tool for first check valves that are relatively large in size and at least one removal tool for second check valves that are relatively small in size. With such a kit, a user will be equipped to engage relatively large first and check valves that are most likely to be encountered.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible within the scope of the following claims.

What is claimed is:

1. A tool adapted for engaging a first check valve of a backflow prevention device comprising:
a frame having a central portion and an end leg portion provided at each end of the central portion, the end leg portions being angled at substantially 90 degrees relative to the central portion; and
a first transverse leg portion extending from the central portion of the frame, the first transverse leg portion including a first portion that extends directly from the central portion at substantially 90 degrees relative thereto and a second portion that extends at substantially 90 degrees relative to the first portion, the second portion being substantially parallel to the end leg portions,
the end leg portions and the first transverse leg portion being configured to be at least partially received in a respective recess provided in a first check valve of a backflow prevention device.

2. The tool of claim 1, further including a brace, wherein the brace is attached at one end to the first transverse leg portion and wherein the brace is attached at another end to one of the end leg portions.

3. The tool of claim 1, further including a second transverse leg portion extending from the central portion of the frame on an opposite side thereof from the first transverse leg portion, wherein the second transverse leg portion includes a first portion that extends directly from the central portion at substantially 90 degrees relative thereto and a second portion that extends at substantially 90 degrees relative to the first portion, wherein the second portion is substantially parallel to the end leg portions, and wherein the second transverse leg portion is configured to be at least partially received in a respective recess provided in a first check valve of a backflow prevention device.

4. The tool of claim 3, wherein the second transverse arm is offset from the first transverse arm.

5. The tool of claim 3, further including a brace, wherein the brace is attached at one end to the second transverse leg portion and wherein the brace is attached at another end to one of the end leg portions.

6. The tool of claim 1, wherein the tool is adapted for engagement by another tool.

7. The tool of claim 6, wherein the tool includes a structure having an opening sized to receive and engage at least a portion of a male fitting of a socket wrench.

8. The tool of claim 6, wherein the structure is a socket.

9. The tool of claim 1, wherein the central portion of the frame is substantially straight.

10. A tool adapted for engaging a second check valve of a backflow prevention device comprising:
a body having an axis of rotation, the body including a plurality of arms extending radially outward from the axis of rotation, the arms being configured to engage a respective pin provided on a second check valve of a backflow prevention device.

11. The tool of claim 10, wherein the arms are substantially straight and are substantially coplanar.

12. The tool of claim 10, wherein at least one of the arms is angled at substantially 90 degrees relative to a neighboring arm.

13. The tool of claim 10, wherein at least one of the arms is angled at about 60 degrees or less relative to a neighboring arm.

14. The tool of claim 10, wherein the tool is adapted for engagement by a socket wrench.

15. The tool of claim 10, wherein the tool has four arms, wherein a first pair of arms is substantially aligned with each other, and wherein a second pair of arms is substantially aligned with each other.

16. The tool of claim 10, wherein the tool has four arms, wherein a first pair of arms is substantially aligned with each other so as to define a longitudinal axis, wherein the four arms are arranged on substantially only one side of the longitudinal axis.

17. A method of removing check valves from a backflow prevention device, the backflow prevention device including housing and a first check valve threadably engaging the housing, the first check valve including a plurality of recesses formed therein, the method comprising:
providing a tool having:
a frame with a central portion and an end leg portion provided at each end of the central portion and angled at substantially 90 degrees relative to the central portion; and
a first transverse leg portion extending from the central portion of the frame, the first transverse leg portion including a first portion that extends directly from the central portion at substantially 90 degrees relative thereto and a second portion that extends at substantially 90 degrees relative to the first portion, the second portion being substantially parallel to the end leg portions,
the end leg portions and the first transverse leg portion being configured to be at least partially received in a respective recess provided in a first check valve of a backflow prevention device,
bringing the tool into engagement with the first check valve such that each of the end leg portions and the first transverse leg portion is at least partially received in a respective one of the recesses in the first check valve.

18. The method of claim 17, further including applying a force to the tool so as to rotate the tool about an axis of rotation, and thereby turning the first check valve.

19. The method of claim 17, wherein the first check valve includes a base, and wherein the recesses are formed in the base.

20. The method of claim 17, wherein the backflow prevention device further includes a second check valve threadably engaging the housing, the second check valve including a plurality of pins provided thereon, the method further comprising:
providing a tool having a body and an axis of rotation, the body including a plurality of arms extending radially outward from the axis of rotation; and
bringing the tool into engagement with the second check valve such that each of the arms engages is a respective one of the pins provided on the second check valve.
